(19) United States
(12) Patent Application Publication
(10) Pub. No.: US 2010/0129510 A1
(43) Pub. Date: May 27, 2010

(54) Beverage Composition

(76) Inventors: Ellen Maria Elizabeth Mulder, Wormerveer (NL); Ulrike Schmid, Wormerveer (NL); Jeroen Monster, Wormerveer (NL)

Correspondence Address: MORGAN LEWIS & BOCKIUS LLP, 1111 PENNSYLVANIA AVENUE NW, WASHINGTON, DC, 20004, US

(21) Appl. No.: 12/597,225

(22) PCT Filed: Apr. 23, 2008
(86) PCT No.: PCT/EP08/03264

§ 371 Date: Dec. 14, 2009

(30) Foreign Application Priority Data
Apr. 24, 2007 (EP) 07251721.2

(51) Int. Cl. A23L 2/68; A23L 2/44; A23L 2/42; A23L 2/60; A23L 2/58; A23L 2/56; A23L 2/39; A23L 2/02; A23F 3/14; A23F 5/10; A23C 9/133; A23C 9/137

(52) U.S. Cl. 426/330.3; 426/590; 426/599; 426/583; 426/588; 426/573; 426/577; 426/575; 426/576; 426/548; 426/597; 426/594; 426/593; 426/541

(57) ABSTRACT

A beverage composition comprises fat, protein and water, said fat comprising at least 5% by weight of pinolenic acid or a derivative thereof.

This invention relates to a beverage composition and to a process for its production.

The nutritional value of the diet has come under increasing scrutiny. Food supplements are often taken by individuals in order to obtain nutritional benefits. However, food supplements are typically in the form of capsules or the like and have the disadvantage that they are inconvenient in that individual has to remember to take them. Food supplements of this type are typically not flavoured and are not attractive to many consumers.

Nutritional supplements have been incorporated into food products but the resulting food products can have an undesirable taste and the incorporation of the supplement can have a deleterious effect on the stability of the products.

WO 2006/109194 describes chromium-fatty acid compounds and their use in various compositions for health effects.

Pinolenic acid (i.e., 5, 9, 12 C18:3 fatty acid, a fatty acid with 18 carbon atoms having three cis double bonds in the positions 5, 9 and 12) is present in, for example, pine nut oil and fractions thereof (see J Am Oil Chem Soc 1998, 75, p. 45-50). Pinolenic acid, as a highly unsaturated fatty acid, can be expected to suffer from the problem of low oxidative stability, particularly when incorporated into foods and beverages.

EP-A-1088552 describes compositions containing pinolenic acid and the use of pinolenic acid as a health component.

WO 2007/053846 relates to compositions of Hoodia gordonii and pinolenic acid derivatives.

FR-A-2756465 discloses the use of a concentrate with 15% pinolenic acid in various compositions, including food additives. The presence of pinolenic acid is described as providing a hypolipemic effect to the composition. There is no indication in the document as to how a food composition can be prepared and no examples are given.

EP-A-1685834 relates to the use of pinolenic acid and its derivatives for weight management by reducing the feeling of hunger and/or increasing satiety. A variety of product forms are mentioned.

It has now been found that a convenient vehicle for the consumption of pinolenic acid and its derivatives can be provided by certain beverage compositions. Surprisingly, it is possible to incorporate the pinolenic acid or derivative in these compositions in relatively high amounts and yet still achieve good oxidative stability compared to other, less saturated oils. The compositions also have good organoleptic properties (including taste and texture) and good stability. Additionally, it is possible for the compositions to have a low calorie content and still achieve these advantages.

Accordingly, the present invention provides a beverage composition comprising fat, protein and water, said fat comprising at least 5% by weight of pinolenic acid or a derivative thereof.

In another aspect, the invention provides a process for producing a beverage composition of the invention, which comprises:
(i) forming an emulsion of the fat in water in the presence of a protein;
(ii) forming a dispersion or solution of a thickening agent in water;
(iii) mixing the compositions prepared in steps (i) and (ii) under shear;
(iv) optionally adding one or more additional ingredients;
(v) optionally homogenising and/or pasteurising; and
(vi) optionally cooling.

In yet another aspect, the invention provides the use of a beverage composition of the invention for a nutritional benefit. A preferred benefit is a weight management effect, for example due to a feeling of satiety.

It has been found that by combining fat, protein and water according to the invention and adapting the level of pinolenic acid or derivative in the fat phase, it is possible to obtain a beverage having one or more of: improved taste; more refreshing taste; stability in that there is little phase separation; no problems with aggregation and for flocculation of particulate matter; no creaming; optimal cloudiness (some drinks should be cloudy, whilst others should not); good homogeneity; enhanced viscosity; good colour; a good level of sweetness; balanced flavour; a light feeling in the mouth; little or no aftertaste; and an optimal droplet size distribution. The higher viscosity that may be achieved from the fat phase can surprisingly provide advantages over compositions containing conventional thickeners. Many or all of these positive effects preferably persist over time e.g., all of the effects remain positive over a period of at least 3 months, preferably about 6 to 12 months. Surprisingly, these positive attributes can be achieved in beverages having relatively low energy contents. This means that it is possible to produce a low calorie product, particularly in a fruit-based beverage, comprising pinolenic acid or a derivative of pinolenic acid.

Moreover, despite the level of unsaturation of pinolenic acid, the beverages have unexpectedly good oxidative stability when compared to other oils, such as high oleic sunflower oil, sunflower oil, CLA and fish oils.

A synergistic nutritional effect may also be present between the fat phase of the drinks and other components in the drinks, for example fruit puree, extra vitamins in the fruit, cocoa and/or green tea extract. An example of such an effect is an enhancement of the weight management effect due to a feeling of satiety.

Preferably, the beverage comprises from 0.5 to 10%, more preferably from 1.0 to 10% by weight of protein, even more preferably from 2 to 8% by weight of protein. The protein can be added as such in a relatively concentrated from (e.g., having a protein content of greater than 70% by weight) or may form part of another material that is included in the composition, such as milk or yoghurt, for example. Preferably, the protein is selected from the group consisting of whey solids, skimmed milk powder and soya protein, low fat yoghurt, skimmed milk and mixtures thereof.

Preferably, the fat content of the beverage composition may be such that the beverage contains from 0.5 to 10% by weight fat, more preferably from 2 to 8% by weight fat, even more preferably from 3 to 7% by weight fat.

Typically, the fat comprises at least 10% by weight of pinolenic acid or a derivative thereof, more preferably from 12 to 45% by weight of pinolenic acid or a derivative thereof, based on the weight of the fat.

Beverage compositions of the invention preferably comprise at least 60% by weight of water, more preferably at least 70% by weight water, even more preferably from 80 to 95% by weight water. Water can be included as relatively pure water or as part of another material such as, for example, milk, yoghurt or fruit juice. Thus, the beverage compositions of the invention may comprise yoghurt, for example.

Preferably, the beverages of the invention comprise a thickening agent. Suitable thickening agents include gum acacia, modified food starches (e.g., alkenylsuccinate modified food starches), anionic polymers derived from cellulose (e.g. carboxymethylcellulose), gum ghatti, modified gum ghatti, xanthan gum, tragacanth gum, guar gum, locust bean gum, pectin, gelatine, carrageenan and mixtures thereof.

Preferably, the thickening agent is selected from the group consisting of pectin, carrageenan, guar gum, gelatin, xanthan gum and mixtures thereof.

Typical amounts of the thickening agent are from 0.001 to 10% by weight of the compositions, more preferably from 0.1 to 5% by weight, preferably from 0.2 to 4% by weight.

Preferably, the beverage composition of the invention is a low calorie product. For example, the beverage composition may have an energy content of less than 100 kcal/100 g, more preferably less than 80 kcal/100 g, even more preferably from 55 to 75 kcal/100 g. Calorie contents can be determined by methods well known to those skilled in the art, for example, as set out in Mullan, 2006, Labelling Determination of the Energy Content of Food: http://www.dairyscience.info/energy_label.asp#3 and/or FAO Food And Nutrition Paper 77, Food energy—methods of analysis and conversion factors, Report of a Technical Workshop, Rome, 3-6 Dec. 2002, Food And Agriculture Organization of the United Nations, Rome, 2003, ISBN 92-5-105014-7.

The compositions of the invention preferably comprise less than 8% by weight of added sugar (i.e., sucrose), more preferably less than 4% by weight of added sugar. The compositions may be substantially free or free of added sugar. Added sugar excludes sugars (i.e., sucrose) that are added as part of another component of the composition. The beverage compositions may comprise sugar replacers. Examples of sugar replacers include sorbitol, mannitol, isomaltitol, xylitol, isomalt, lactitol, hydrogenated starch hydrolysates (HSH, including maltitol syrups) and mixtures thereof. Additionally or alternatively, the compositions may comprise a sweetening agent. Suitable sweetening agents include saccharin, aspartame, sucralose, neotame, acesulfame potassium, acesulfame, taumatine, cyclamate and mixtures thereof. More preferred sweetening agents are selected from aspartame, acesulfame-K and mixtures thereof.

Beverage compositions of the invention optionally comprise one or more additional additives selected from flavours, colouring agents, vitamins, minerals, acidity regulators, preservatives, emulsifiers, antioxidants, dietary fibres and mixtures thereof. Each of these materials may be a single component or a mixture of two or more components.

Examples of suitable vitamins and minerals include calcium, iron, zinc, copper, phosphorous, biotin, folic acid, pantothenic acid, iodine, vitamin A, vitamin C, vitamin B1, vitamin B2, vitamin B3, vitamin B6, vitamin B9, vitamin B12, vitamin D, vitamin E, and vitamin K. Preferably, when a vitamin or mineral is utilized the vitamin or mineral is selected from iron, zinc, folic acid, iodine, vitamin A, vitamin C, vitamin Be, vitamin B3, vitamin B6, vitamin B12, vitamin D, and vitamin E.

Acidity regulators include organic as well as inorganic edible acids. The acids can be added or be present in their undissociated form or, alternatively, as their respective salts, for example, potassium or sodium hydrogen phosphate, potassium or sodium dihydrogen phosphate salts. The preferred acids are edible organic acids which include citric acid, malic acid, fumaric acid, adipic acid, phosphoric acid, gluconic acid, tartaric acid, ascorbic acid, acetic acid, phosphoric acid, or mixtures thereof. Glucono Delta Lactone (GDL) may also be used, particularly wherein it is desired to reduce pH without introducing excessive acidic, or tart, flavour in the final composition.

Flavours include, for example, flavour oils, extracts, oleoresins, essential oils and the like, known in the art for use as flavourants in beverages. This component can also comprise flavour concentrates such as those derived from concentration of natural products such as fruits. Terpeneless citrus oils and essences can also be used herein. Examples of suitable flavours include, for example, fruit flavours such as orange, lemon, lime and the like, cola flavours, tea flavours, coffee flavours, chocolate flavours, dairy flavours. These flavours can be derived from natural sources such as essential oils and extracts, or can be synthetically prepared.

Colouring agents including natural and artificial colours may optionally be used. Non-limiting examples of colouring agents include fruit and vegetable juices, riboflavin, carotenoids (e.g. β-carotene), tumeric, and lycopenes.

Dietary fibres are complex carbohydrates resistant to digestion by mammalian enzymes, such as the carbohydrates found in plant cell walls and seaweed, and those produced by microbial fermentation.

Preservatives may be selected from the group consisting of sorbate preservatives, benzoate preservatives, and mixtures thereof.

Antioxidants include, for example, natural or synthetic tocopherols, TBHQ, BHT, BHA, free radical scavengers, propylgallate, ascorbylesters of fatty acids and enzymes with anti-oxidant properties.

The beverages of the invention may be free of dairy material and, for example, may be free of lactose.

The beverages of the invention may be free of extracts from the genus Hoodia or Trichocaulon, such as Hoodia gordonii.

Beverages of the invention may be carbonated or non-carbonated.

The beverage composition of the invention may take a number of different forms. In one aspect, the beverage is a fruit drink, for example selected from the group consisting of a yoghurt-based fruit drink, a fruit-based smoothie and a fruit-based meal replacer drink. The composition may comprise from 2 to 45% by weight on a wet basis of fruit based material. Wet basis refers to the fruit material including any water associated with it, for example 20% by weight added apple juice corresponds to 20% by weight fruit on a wet basis. More preferably, the composition comprises from 3 to 40% by weight on a wet basis of fruit based material, such as from 5 to 35% by weight on a wet basis of fruit based material. The fruit based material is preferably selected from a fruit puree, fruit concentrate, fruit juice or mixtures thereof. Examples of suitable fruits are orange, banana, pineapple, mango, passion fruit, coconut, blackberry, blueberry, apple, strawberry, cranberry, lemon, lime and mixtures thereof. A particularly preferred fruit based material is banana puree.

Other suitable fruits can be derived from, for example, pear, peach, plum, apricot, nectarine, grape, cherry, currant, raspberry, gooseberry, elderberry, blueberry, grapefruit, mandarin, grapefruit, cupuacu, mango, guava, tomato, rhubarb, carrot, beet, cucumber, pomegranate, kiwi, papaya, watermelon, passion fruit, tangerine, and cantaloupe.

A fruit beverage will usually have a pH of less than 5, more preferably less than 4.5 most preferably a pH between 3.0 and 4.1.

In another aspect, the beverage composition of the invention comprises material derived or extracted from coffee or tea or cocoa or mixtures thereof. The material may be derived directly or indirectly from the plant material, such as coffee beans, tea leaves or cocoa beans, for example by further processing, purification or extraction techniques. In this aspect of the invention, the beverage preferably has an energy content of less than 70 kcal/100 g, more preferably less than 60 kcal/100 g, such as from 40 to 55 kcal/100 g. In one embodiment of this other aspect of the invention, the beverage composition preferably comprises at least 0.1% by weight cocoa, more preferably at least 0.5% by weight cocoa, most preferably from 1 to 2.5% by weight cocoa. Cocoa includes cocoa powder, cocoa mass and cocoa solids. In another embodiment of this other aspect of the invention, the beverage composition comprises at least 0.01% by weight coffee powder, preferably at least 0.04% by weight coffee powder, most preferably 0.05 to 0.3% by weight coffee powder. In a further embodiment of this other aspect of the invention, the beverage composition comprises green tea or a material or extract derived from green tea.

When tea solids are included, the beverages of the present invention preferably comprise from about 0.01% to about 1.2%, preferably from about 0.05% to about 0.8%, by weight of the beverage product, of tea solids. The term “tea solids” as used herein means solids extracted from tea materials including those materials obtained from the genus Camellia including C. sinensis and C. assaimica, for instance, freshly gathered tea leaves, fresh green tea leaves that are dried immediately after gathering, fresh green tea leaves that have been heat treated before drying to inactivate any enzymes present, unfermented tea, instant green tea, and partially fermented tea leaves. Green tea solids are tea leaves, tea plant stems, and other plant materials that are related and which have not undergone substantial fermentation to create black teas. Mixtures of unfermented and partially fermented teas can be used.

The beverage composition may be produced by a method which comprises:

(i) forming an emulsion of the fat in water in the presence of a protein;
(ii) forming a dispersion or solution of the thickening agent in water;
(iii) mixing the compositions prepared in steps (i) and (ii) under shear;
(iv) optionally adding one or more additional ingredients;
(v) optionally homogenising and/or pasteurising; and
(vi) optionally cooling.

Preferably, the method further comprises: (vii) packaging the composition. Packaging includes, for example, cans, bottles and sealed cartons.

Pinolenic acid or a derivative of pinolenic acid is an essential component of the compositions of the invention. The pinolenic acid or derivative (which term is intended to cover both pinolenic acid and derivatives when both are present) is preferably in a form selected from the free acid, salts, mono-, di- or triglycerides, or mixtures thereof.

Sources of pinolenic acid and its derivatives are available and will be known to those skilled in the art. Preferably, the pinolenic acid or derivative is in the form of pine nut oil or is derived from pine nut oil.

The pinolenic acid or derivative in the beverage compositions may form part of a fat composition that comprises one or more other components. The fat will typically be present in the beverage composition in the form of an emulsion, suspension or dispersion. The fat is generally present homogeneously throughout the aqueous phase of the beverage.

In a preferred embodiment of the invention, the pinolenic acid or derivative is in the form of a fat which comprises from 12 to 45%, more preferably from 15 to 40%, such as from 16 to 35%, or from 20 to 30%, by weight pinolenic acid or derivative thereof, based on the total weight of fatty acids in the fat (calculated as free fatty acid).

Examples of other fatty acids that may be present in the fat include linoleic acid, oleic acid, taxoleic, juniperonic, sciadonic, saturated fatty acids, conjugated linoleic acid (optionally as an enriched isomer mixture) and EPA (eicosapentaenoic) and DHA (docosahexaenoic). Enrichment involves the alteration of the isomer mixture normally present (for example in a natural product), such as an alteration in the relative amounts of different geometrical isomers.

Particularly preferred fats used in beverage compositions of the invention are those in which the pinolenic acid or derivative is in the form of a composition which additionally comprises from 30 to 70% by weight linoleic acid or derivative thereof, based on the total weight of fatty acids in the fat (calculated as free fatty acid). Additionally or alternatively, the pinolenic acid or derivative is in the form of a fat which additionally comprises from 10 to 40% by weight oleic acid or derivative thereof, based on the total weight of fatty acids in the fat (calculated as free fatty acid). Additionally or alternatively, the pinolenic acid or derivative is in the form of a fat which additionally comprises from 1 to 15% by weight palmitic acid or derivative thereof, based on the total weight of fatty acids in the fat (calculated as free fatty acid). Additionally or alternatively, the fat may comprise from 0.5 to 5 wt % of taxoleic acid or a derivative thereof.

Specific examples of fats comprising pinolenic acid or a derivative thereof that are useful in the invention include the following:
Fat compositions comprising from 10 to 35%, more preferably from 15 to 30%, by weight pinolenic acid or a derivative thereof, together with from 30 to 70% by weight linoleic acid or a derivative thereof;
Fat compositions comprising from 10 to 35%, more preferably from 15 to 30%, by weight pinolenic acid or a derivative thereof, together with from 10 to 40% by weight oleic acid or a derivative thereof;
Fat compositions comprising from 10 to 35%, more preferably from 15 to 30%, by weight pinolenic acid or a derivative thereof, together with from 1 to 15% by weight palmitic acid or a derivative thereof;
Fat compositions comprising from 10 to 35%, more preferably from 15 to 30%, by weight pinolenic acid or a derivative thereof, together with from 0.5 to 5 wt % of taxoleic acid or a derivative thereof;
Fat compositions comprising from 10 to 35%, more preferably from 15 to 30%, by weight pinolenic acid or a derivative thereof, together with from 30 to 70% by weight linoleic acid or a derivative thereof and from 10 to 40% by weight oleic acid or a derivative thereof;
Fat compositions comprising from 10 to 35%, more preferably from 15 to 30%, by weight pinolenic acid or a derivative thereof together with from 30 to 70% by weight linoleic acid or a derivative thereof and from 1 to 15% by weight palmitic acid or a derivative thereof;
Fat compositions comprising from 10 to 35%, more preferably from 15 to 30%, by weight pinolenic acid or a derivative thereof together with from 30 to 70% by weight linoleic acid or a derivative thereof and from 0.5 to 5 wt % of taxoleic acid or a derivative thereof;
Fat compositions comprising from 10 to 35%, more preferably from 15 to 30° A, by weight pinolenic acid or a derivative thereof together with from 30 to 70% by weight linoleic acid or a derivative thereof, from 1 to 15% by weight palmitic acid or a derivative thereof and from 10 to 40% by weight oleic acid or a derivative thereof; and
Fat compositions comprising from 10 to 35%, more preferably from 15 to 30%, by weight pinolenic acid or a derivative thereof, together with from 30 to 70% by weight linoleic acid or a derivative thereof, from 1 to 15% by weight palmitic acid or a derivative thereof, from 10 to 40% by weight oleic acid or a derivative thereof and from 0.5 to 5 wt % of taxoleic acid or a derivative thereof.

In these fats, the amounts of the acids or derivatives are determined as free acid based on the total fatty acid and/or derivative content of the fat. Preferably, the fatty acids are present as glycerides (more preferably triglycerides) (i.e., more than 90%, preferably more than 95%, by weight of the fatty acids are present as glycerides, more preferably triglycerides). Another preferred glyceride is the diglyceride.

In a preferred embodiment of the invention, the pinolenic acid or derivative represents at least 75% by weight of the total Δ5-polyunsaturated C18-C20 fatty acids in the fat (calculated as free fatty acid).

The pinolenic acid used in the present invention may be in the form of a free fatty acid, a derivative of pinolenic acid or mixtures thereof, including mixtures of different derivatives. Derivatives are non-toxic and edible. Derivatives of pinolenic acid, which can be used in the present invention, include salts of pinolenic acid and esters. Isomers of pinolenic acid and their derivatives can be used in the invention such as, for example, geometric isomers (having one or more trans double bonds; the double bonds in pinolenic acid are all cis). Although the pinolenic acid (and its derivatives) is preferably the 5, 9, 12 cis isomer, possible derivatives of pinolenic acid also include compounds having 18 carbon atoms and three double bonds with one or more of the three double bonds at a different position in the alkyl chain compared to pinolenic acid, including, for example, gamma linolenic acid, alpha linolenic acid, punicic acid, eleostearic acid, and their salts and alkyl esters. Suitable salts include salts with food grade cations such as sodium salts and calcium salts. Suitable esters include alkyl esters having from one to six carbon atoms. Preferred derivatives are esters and preferred esters are mono-, di- and tri-glycerides and mixtures thereof.

The other fatty acid or each of the other fatty acids in the fat can independently be present as a free fatty acid or as a derivative thereof (including a mono-, di- or triglyceride and salts, preferably glycerides), or as a mixture thereof.

A suitable source for the pinolenic acid used in the present invention is pine nut oil or concentrates thereof. For example, glycerides of pinolenic acid can be obtained from pine nut oil or concentrates thereof. Preferably, an oil or concentrate with a content of pinolenic acid or a derivative thereof of more than 15% by weight or more than 28% by weight is used (such as up to 50% by weight).

Concentrates of pinolenic acid or a derivative thereof that may be used in the present invention can be prepared by any suitable process. A suitable process is described in EP-A-1088552.

In one suitable process, an enzymic hydrolysis or glycerolysis is performed using an enzyme that can discriminate between fatty acids with a delta 5 double bond and other fatty acids. This process comprises:
i) reacting a glyceride material containing at least 2% by weight of fatty acid with cis⁵ double bond with water or glycerol in the presence of an enzyme capable of discriminating between fatty acids containing a delta 5 double bond and other fatty acids;
ii) splitting the reaction mixture into a partial glyceride rich component and a fatty acid rich component;
iii) optionally converting the partial glycerides of step ii) to free fatty acids in the presence of a suitable enzyme;
iv) optionally converting the fatty acid rich component of step ii) to triglycerides by reaction with glycerol in the presence of a suitable catalyst such as a suitable enzyme; and
v) optionally splitting the partial glyceride rich material of step ii) into components that are a) rich in monoglycerides, b) rich in diglycerides and c) rich in triglycerides and then optionally converting the partial glycerides a) and b) into triglycerides by reaction with fatty acids in the presence of a suitable enzyme.

It is preferred to use a glyceride material with a pinolenic acid content of 5 to 50 wt %, preferably 10 to 35 wt % in step i). Examples of such materials are pinolenic oils and concentrates thereof. This process produces a concentrate that contains at least 28% by weight pinolenic acid.

Enzymes suitable for use in steps i), iii), iv) and v) are lipases. Suitable commercial lipases include Candida rugosa lipase; Lipase QL; Lipase SL, Lipase OF; Rhizopus delemar; lipase; Rhizopus oryzae lipase; Geotrichum candidum B lipase; and Rhizomucor miehei lipase. Preferred enzymes for step i) are Candida rugosa lipase and Geotrichum candidum B lipase.

Suitable lipases also include Lipozyme IM (a commercial enzyme). The preferred enzyme for use in step iv) is Lipozyme M (from Rhizomucor miehei).

The fats comprising pinolenic acid or a derivative thereof that are useful in the invention may comprise one or more other fatty acids. The term fatty acid, as used herein, refers to straight chain carboxylic acids having from 12 to 24 carbon atoms and being saturated or unsaturated e.g., having 0, 1, 2 or 3 double bonds.

The pinolenic acid or derivative thereof is optionally blended with additional fatty acids or glycerides before being used in the fat of the present invention. When the compositions contain one or more fatty acids and/or glycerides in addition to the pinolenic acid or derivative thereof, the additional fatty acid(s) and/or glycerides are preferably selected from liquid oils, such as soybean oil, sunflower oil, rape seed oil and cotton seed oil; cocoa butter and cocoa butter equivalents; palm oil and fractions thereof; enzymically made fats; fish oils and fractions thereof; conjugated linoleic acid and enriched isomer mixtures; gamma linolenic acid and enriched mixtures thereof; hardened liquid oils; and mixtures thereof.

The pinolenic acid or derivative thereof can be included in the beverage of the invention as an oil or in the form of a powder, such as a free flowing powder. Pinolenic acid and its derivatives in powder form can be produced, for example, by spray drying pinolenic acid or its derivatives, or a fat comprising pinolenic acid or its derivatives, with protein and/or carbohydrate, with the powder typically comprising from 50 to 90% by weight of fat. It has been found that use of the powder can give extra stability to the beverage.

The listing or discussion of an apparently prior-published document in this specification should not necessarily be taken as an acknowledgement that the document is part of the state of the art or is common general knowledge.

The following non-limiting examples illustrate the invention and do not limit its scope in any way. In the examples and throughout this specification, all percentages, parts and ratios are by weight unless indicated otherwise.

### EXAMPLES

### Example 1

### Fruit Drink Comprising Pinolenic Acid Triglyceride

Batch size [kg] 100

| | | | | | | | Fruit | |
|---|---|---|---|---|---|---|---|---|
| | | | | | Pectin | whey | juice | Pre- |
| | | Dosage | Dosage | Direct | solution | protein | yoghurt | emulsion |
| Ingredient | Supplier | [%] | [g] | [g] | 4% | solution | solution | 25% |
| Low fat | | 41.40% | 41400 | | | | 27600 | 13800 |
| yoghurt | | | | | | | | |
| Orange | SVZ | 4.70% | 4700 | | | | 4700 | |
| juice | | | | | | | | |
| concentrate | | | | | | | | |
| 65°Brix | | | | | | | | |
| Apple juice | SVZ | 5.00% | 5000 | | | | 5000 | |
| concentrate | | | | | | | | |
| 65°Brix | | | | | | | | |
| PinnoThin | Lipid | 4.60% | 4600 | | | | | 4600 |
| | Nutrition | | | | | | | |
| Sugar | | 3.50% | 3500 | | | | 3500 | |
| Whey | Friesland | 2.00% | 2000 | | | 2000 | | |
| protein | Foods | | | | | | | |
| powder | | | | | | | | |
| 35% | | | | | | | | |
| Hiprotal | | | | | | | | |
| 835 | | | | | | | | |
| Pectin | Danisco | 0.35% | 350 | | 350 | | | |
| Grinsted | | | | | | | | |
| AMD783 | | | | | | | | |
| Flavour | Quest | 0.05% | 50 | 50 | | | | |
| lemon | | | | | | | | |
| QL16062 | | | | | | | | |
| Flavour | Quest | 0.05% | 50 | 50 | | | | |
| passion | | | | | | | | |
| fruit | | | | | | | | |
| QL20510 | | | | | | | | |
| Colour | Chr. | 0.01% | 10 | 10 | | | | |
| annatto | Hansen | | | | | | | |
| A-720-WS- | | | | | | | | |
| AP | | | | | | | | |
| Colour | Chr. | 0.005% | 5 | 5 | | | | |
| turmeric | Hansen | | | | | | | |
| T-PT8-WS | | | | | | | | |
| Splenda | Tate&Lyle | 0.007% | 7 | | | | 7 | |
| sucralose | | | | | | | | |
| Sodium | | 0.40% | 400 | 400 | | | | |
| citrate to | | | | | | | | |
| pH = 4.0 +/− | | | | | | | | |
| 0.1 | | | | | | | | |
| Water | | 37.93% | 37928 | | 8400 | 29528 | | |
| Total | | 100.00% | 100000 | 515 | 8750 | 31528 | 40807 | 18400 |

PinnoThin is a trademark of Lipid Nutrition BV and comprises, as triglycerides (in weight %):

| | |
|---|---|
| Pinolenic acid | 16 |
| Linoleic acid | 46 |
| Oleic acid | 25 |
| Palmitic acid | 4 |
| Taxoleic acid | 2 |
| Others | balance to 100 |

A 4% solution of pectin in hot water of >90° C. was prepared. The whey protein powder was dispersed in the rest of water heated to 40° C. and hydrated at least for 15 minutes. Next the fruit juice yoghurt solution was made by mixing 27.6 kg yoghurt with the apple juice and orange juice concentrate, the sugar and the sweetener. Then a 25% pre-emulsion of PinnoThin™ pinolenic acid triglyceride (Lipid Nutrition BV, Wormerveer, The Netherlands) in the rest of the yoghurt was made by heating the yoghurt to 60° C. and slowly mixing in PinnoThin™. The mixture was homogenised dual-stage 200/50 bar and cooled to 4° C. until further use.

The fruit juice yoghurt solution was mixed with pectin solution, whey protein solution and the pre-emulsion. Sodium citrate was added to adjust the pH to 4+/−1. Then the flavours and colourants were added. The whole mixture was pre-heated to 40° C., homogenised dual-stage 180/18 bar, heated 5 s to 104° C. and cooled to 5° C. As last step the mixture was filled aseptically.

The beverage contains 9.70% by weight fruit on a wet basis.

### Example 2

### Meal Replacer Breakfast Smoothie Comprising Pinolenic Acid Triglyceride

Meal replacer breakfast smoothie with PinnoThin™:
3 gram PinnoThin™ per serving of 250 ml
11% fruit
Orange-banana-mango-flavour
Complies with EU directive 96/8/EC on foods intended for use in energy-restricted diets for weight reduction.

### Formulation

| | |
|---|---|
| 65.0 | Non-fat yoghurt with 4.5% protein |
| 5.0 | Sugar |
| 4.4 | Banana puree |
| 3.0 | Whey protein concentrate 80% protein Hiprotal 580 (Friesland |
| | Foods Domo) |
| 2.0 | Inulin Frutafit IQ (Sensus) |
| 1.5 | PinnoThin ™ |
| 1.09 | Orange juice concentrate 65°Brix |
| 0.7 | Citric acid 50% till pH 4.0 |
| 0.6 | Sunflower oil |
| 0.4 | Pectin Grindsted ® AMD 783 (Danisco) |
| 0.37 | Sweetener (aspartame, acesulfame-K, maltodextrin) |
| 0.18 | Vitamin/mineral blend |
| 0.05 | Orange flavour QL25307 (Quest International) |
| 0.05 | Mango flavour QL14321 (Quest International) |
| 15.76 | Water till 100% |

A 25% solution of whey protein concentrate powder in water of 40° C. was prepared, let hydrated at least 15 minutes. Pectin was premixed with 50% of sugar. The pectin-sugar mixture was added to the rest of water and heated to >90° C. The syrup was cooled and orange juice concentrate was added to the syrup. A 21% pre-emulsion of PinnoThin™ and sunflower oil in yoghurt was made. The yoghurt (75%) was heated to 60° C. and slowly mixed-in PinnoThin™ and sunflower oil. The pre-emulsion was homogenised dual-stage 200/50 bar and cooled to 4° C. until further use. The rest of yoghurt was stirred by avoiding air uptake. Whey protein concentrate solution, inulin, sugar, sweetener, pectin syrup and banana puree were added. The pH was adjusted to 4.0 with 50% citric acid solution. Then vitamin/mineral blend and flavours were added. The pre-emulsion was added and pH was checked and adjusted to pH 4.0 if necessary. The whole mixture was pre-heated to 40° C., homogenised dual-stage 180/18 bar, heated 20 s 90° C., cooled to 5° C. and filled aseptically.

Nutritional information (per serving of 250 g):

| | |
|---|---|
| Energy | 205 kcal/863 kJ |
| Protein | 13.6 g |
| Carbohydrate | 24.0 g |
| Fat | 5.5 g |
| PinnoThin ™ | 3.0 g |
| Linoleic acid | 1.0 g |
| Dietary fiber | 5.3 g |

And at least 30% of Recommended Daily Intake for vitamins A, D, E, C, thiamin, riboflavin, niacin, B6, folate, B12, biotin, pantothenic acid, calcium, phosphorous, potassium, iron, zinc, copper, iodine, selenium, sodium, magnesium, manganese according to EU directive 96/8/EC.

### Example 3

### Example for a One-Shot Soy Fruit Smoothie Comprising Pinolenic Acid Triglyceride

One-shot fruit-soy smoothie with PinnoThin™:
3 gram PinnoThin™ per serving of 65 gram
76 mg calcium per serving of 65 gram
30% fruit
raspberry flavour
100% non-dairy

### Formulation

| | |
|---|---|
| 5.0 | Banana puree |
| 4.6 | PinnoThin ™ |
| 4.4 | Raspberry puree |
| 3.5 | Sugar |
| 2.54 | Apple juice concentrate |
| 2.44 | Nutrisoy ™ Organic Whole Soybean Powder (ADM) |
| 0.78 | Raspberry juice concentrate |
| 0.4 | Pectin Grindsted ® AMD383 (Danisco) |
| 0.3 | Tri-calcium phosphate |
| 0.3 | Citric acid 50% till pH 3.9 |
| 0.11 | Elderberry juice concentrate |
| 0.06 | Raspberry flavour 78726-33 (Givaudan) |
| 0.05 | Carmine CC-1000-WS (Chr. Hansen) |
| 0.03 | Vanilla flavour 2A02405 (Quest International) |
| 0.0058 | Splenda ® sucralose (Tate & Lyle) |
| 75.5 | Water till 100% |

The soybean powder was dispersed in water of 50° C. (7.5% solution) and hydrated for 40 minutes. A 4% solution of pectin in hot water of 90° C. was prepared. The soy and pectin solutions were mixed and PinnoThin™ slowly added while using high-shear mixing. The emulsion was homogenised at 200/50 bar at 50° C. and cooled to 4° C. till further use. The fruit juice and purees were mixed with the remaining water. Sugar, sweetener and tri-calcium phosphate was added to the fruit. Then the fruit was added to the PinnoThin™ emulsion. Furthermore flavours and colourant were added. The pH was adjusted to 3.9 with 50% citric acid solution. The whole mixture was pre-heated to 40° C., homogenized dual-stage 150/30 bar, pasteurised 5 s at 104° C., cooled to 20° C. and filled aseptically.

Nutritional information (per serving of 65 g):

| Energy | 53 kcal/221 kJ | |
|---|---|---|
| Protein | 0.7 | g |
| Carbohydrate | 5.0 | g |
| Fat | 3.4 | g |
| PinnoThin ™ | 3.0 | g |
| Dietary fiber | 0.6 | g |
| Calcium | 76 | mg |

### Example 4

### Low Calorie Yoghurt Fruit Drink with Pinolenic Acid Triglyceride

Yoghurt fruit drink with PinnoThin™:
3 gram PinnoThin™ per serving of 65 gram
Lemon/orange/tropical fruit flavour

### Formulation (wt %)

| | |
|---|---|
| 41.4 | Low fat yoghurt (0% fat) |
| 4.6 | PinnoThin ™ |
| 2.0 | Apple juice concentrate |
| 2.0 | Orange juice concentrate |
| 2.0 | Whey protein powder 35% Hiprotal 835 (Friesland Foods) |
| 0.35 | Pectin Grindsted ® AMD383 (Danisco) |
| ±0.4 | Sodium citrate till pH = 4.0 |
| 0.05 | Flavour lemon QL16062 (Quest International) |
| 0.05 | Flavour tropical fruit (Givaudan) |
| 0.013 | Sucralose Splenda (Tate&Lyle) |
| 0.01 | Colour annatto A-720-WS-AP (Chr. Hansen) |
| 0.005 | Colour turmeric T-PT8-WS (Chr. Hansen) |
| 47.1 | Water to 100% |

A 4% solution of pectin syrup in hot water of >90° C. is prepared and cooled. The apple juice concentrate and the orange juice concentrate are mixed and the sweetener dissolved in the mixture. A 25% pre-emulsion of PinnoThin™ in yoghurt (75%) is made by heating the yoghurt to 60° C. and slowly mixing in PinnoThin™. The mixture is homogenised dual-stage 200/50 bar and cooled to 4° C. until further use.

The fruit juice solution is mixed with the remaining yoghurt and pectin and pre-emulsion solution are added. Sodium citrate is added to adjust the pH to pH=4+/−0.1. Then flavours and colourants are added. The solution is homogenised dual-stage at 200′50 bar, heated 5 s to 104° C. and cooled to 5° C. The yoghurt drink is filled into bottles, pasteurized and stored at 5° C.

Nutritional information (per serving of 65 gram):

| | |
|---|---|
| Energy | 46.0 kcal/191 KJ |
| Protein | 1.6 g |
| Carbohydrate | 3.0 g |
| Fat | 3.0 g |
| PinnoThin ™ | 3.0 g |

### Example 5

### Stability of Pinolenic Acid in Beverage Compositions of the Invention

4.8 1 of yoghurt drink was prepared comprising 4.6 g pinolenic acid triglyceride (PinnoThin™ from Lipid Nutrition BV, Wormerveer, The Netherlands) or 4.6 g safflower oil/100 g yoghurt drink without adding any colors or flavors.

### Recipe:

The following yoghurt drinks are prepared:

### Formulation (%)

| | |
|---|---|
| 70.0 | Low fat yogurt (0.5% fat)¹ |
| 4.6 | Pinnothin or Safflower oil² |
| 5.0 | Sugar |
| 2.0 | Whey protein powder (Friesland Foods) |
| 0.325 | Pectin Grindsted ® AMD783 (Danisco) |
| 0.007 | Splenda ® sucralose (Tate & Lyle) |
| 18.068 | Water till 100% |
| | Sodium citrate/citric acid till pH = 4.0 +/− 0.1 |

¹Friese Vlag, 0.5% milkfat
²All oils had the same amount of antioxidant mixture: 2500 ppm rosemary extract and 1000 ppm d-mixed tocopherols (=2000 ppm Tocoblend L50-IP) Used Rosemary extract: Herbalox ® seasoning, HT-O, NS; code 41-19-25; Lotno. 707976K

A solution of a 4% pectin in hot water of >90° C. was prepared.

Whey protein powder was dispersed in the rest of water, heated to 40° C. and hydrated for at least 15 minutes.

A 25% pre-emulsion of the oil in yoghurt was made. The yoghurt was heated to 60° C. and slowly the oil was mixed-in. The mixture was homogenized dual-stage 200/50 bar and cooled to 4° C. till further use. Sugar, sweetener (100× solution in water), pectin solution, whey protein solution and pre-emulsion were added to this mixture. Sodium citrate/citric acid till pH=4+/−0.1 was added. The mixture was pre-heated to 40° C., homogenized dual-stage 200/50 bar, and filled in bottles.

For each of the oils the following experimental set up was prepared:

9 samples containing 400 ml yoghurt drink were prepared. 4 samples were stored at 7° C. and 4 bottles at 25° C. One sample of 400 ml yoghurt was directly processed by extracting the oil with the methanol/chloroform extraction method (starting sample). After 2, 4, 7 and 10 days of storage. the oil was extracted from each sample with the methanol/chloroform extraction method.

The extracted oils were tested for rancimat analysis.

As comparison all oils were stored and extracted the same way as described above:

Separate samples of PinnoThin and safflower oil were prepared and stored at 7° C. and at 25° C., respectively. After 2, 4, 7 and 10 days from each storage, the oil was extracted with the methanol/chloroform extraction procedure.

### Fat Extraction Procedure for Yoghurt Drinks:

All yoghurt drink mixtures were extracted in 4 portions; this is due to the workability of the samples together with the solvents which are needed to conduct the extractions.

To about 100 g of yoghurt mixture about 10 g of KCl, 100 ml chloroform and 50 ml methanol were added. The samples were put on a turax for 3 minutes with a speed of about 12000 rpm. The mixture was divided in 2×100 g bottles. This procedure was repeated 4 times until 8×100 g bottles were received. The bottles were centrifuged for 5 minutes at 4500 rpm. The upper layer of each bottle was removed with a pipette. The lower layer together with the white pellet which was received after centrifugation was put over a filter. The filtrate was put in an empty flask on the rotor vapour equipment. The temperature of the water bath was set at 35° C. and the pressure slowly brought down to about 20 mbar. Nitrogen was bubbled through the sample overnight.

### Results

Temperature 4-7° C. Rancimat (AOCS Cd 12b-92)

| | Days | | | | |
|---|---|---|---|---|---|
| | 0 | 2 | 4 | 7 | 10 |
| PinnoThin YD | 3.1 | 2.2 | 2.5 | 2.7 | 2.7 |
| Safflower YD | 5.9 | 3.8 | 1.9 | 4.2 | 1.1 |
| PinnoThin oil | 4.2 | 4.3 | 3.9 | 3.9 | 4.2 |
| Safflower oil | 3.2 | 2.9 | 3.1 | 3.1 | 3.1 |

YD = yoghurt drink

A higher rancimat value indicates a greater stability of the oil. Therefore, the results show that the pinolenic acid is surprisingly stable in the drink compared to safflower oil (another polyunsaturated oil), even though the two oils show similar behaviour as the unformulated oil.

1. Beverage composition comprising fat, from 0.5 to 10% by weight of protein and water, said fat comprising at least 5% by weight of pinolenic acid or a derivative thereof.

2. Beverage as claimed in claim 1, comprising from 2 to 8% by weight of protein.

3. Beverage according to claim 2, which comprises from 2 to 45% by weight on a wet basis of fruit based material.

4. Beverage as claimed in claim 1, wherein the fat comprises at least 10% by weight of pinolenic acid or a derivative thereof.

5. Beverage as claimed in claim 1, wherein the fat comprises from 12 to 45% by weight of pinolenic acid or a derivative thereof.

6. Beverage according to claim 1 comprising from 0.5 to 10% by weight fat.

7. Beverage according to claim 1 comprising from 2 to 8% by weight fat.

8. Beverage according to claim 1, wherein the protein is selected from the group consisting of whey solids, skimmed milk powder and soya protein, or is added as part of a low fat yoghurt or skimmed milk, and mixtures thereof.

9. Beverage according to claim 1 comprising at least 60% by weight of water.

10. Beverage according to claim 1 comprising at least 70% by weight water.

11. Beverage according to claim 1 comprising a thickening agent.

12. Beverage according to claim 11, comprising from 0.001 to 10% by weight of the thickening agent.

13. Beverage according to claim 12, comprising from 0.1 to 5% by weight of the thickening agent.

14. Beverage according to claim 11, wherein the thickening agent is selected from the group consisting of pectin, carrageenan, guar gum, gelatin, xanthan gum and mixtures thereof.

15. Beverage according to claim 1 which is a fruit drink.

16. Beverage according to claim 15 which is selected from the group consisting of a yoghurt-based fruit drink, a fruit-based smoothie and a fruit-based meal replacer drink.

17. Beverage according to claim 1 which has an energy content of less than 100 kcal/100 g.

18. Beverage according to claim 1 which has an energy content of less than 80 kcal/100 g.

19. Beverage according to claim 1 which has an energy content of from 55 to 75 kcal/100 g.

20. Beverage according to claim 1 which comprises less than 8% by weight of added sugar.

21. Beverage according to claim 1 which comprises less than 4% by weight of added sugar.

22. Beverage according to claim 1 which is free of added sugar.

23. Beverage according to claim 1 comprising sugar replacers.

24. Beverage according to claim 1 comprising a sweetening agent.

25. Beverage according to claim 24, wherein the sweetening agent is selected from aspartame, acesulfame-K and mixtures thereof.

26. Beverage according to claim 1, which comprises from 3 to 40% by weight on a wet basis of fruit based material.

27. Beverage according to claim 1, which comprises from 5 to 35% by weight on a wet basis of fruit based material.

28. Beverage according to claim 3, wherein the fruit based material is selected from a fruit puree, fruit concentrate, fruit juice or mixtures thereof.

29. Beverage according to claim 28, wherein the fruit based material is banana puree.

30. Beverage according to claim 1 having a pH of less than 5.

31. Beverage according to claim 1, comprising material derived or extracted from coffee or tea or cocoa or mixtures thereof.

32. Beverage according to claim 31 having an energy content of less than 70 kcal/100 g.

33. Beverage according to claim 31 having an energy content of less than 60 kcal/100 g.

34. Beverage according to claim 31 having an energy content of from 40 to 55 kcal/100 g.

35. Beverage according to claim 31, comprising at least 0.1% by weight cocoa.

36. Beverage according to claim 31, comprising at least 0.01% by weight coffee powder.

37. Beverage according to claim 31, comprising green tea or a material or extract derived from green tea.

38. Beverage according to claim 1 comprising one or more additives selected from flavours, colouring agents, vitamins, acidity regulators, preservatives, emulsifiers, antioxidants, dietary fibres and mixtures thereof.

39. Beverage according to claim 1 which is free of dairy material.

40. Beverage claimed in claim 1, wherein the pinolenic acid or derivative thereof is incorporated in the beverage in the form of a powder.

41. Beverage as claimed in claim 40, wherein the powder is produced by spray drying pinolenic acid or its derivatives, or a fat comprising pinolenic acid or its derivatives, with protein and/or carbohydrate.

42. Beverage as claimed in claim 1, wherein the pinolenic acid is in the form of a glyceride.

43. A process for producing a beverage composition according to claim 1, which comprises:
(i) forming an emulsion of the fat in water in the presence of a protein;
(ii) forming a dispersion or solution of the thickening agent in water;
(iii) mixing the compositions prepared in steps (i) and (ii) under shear;
(iv) optionally adding one or more additional ingredients;
(v) optionally homogenising and/or pasteurising; and
(vi) optionally cooling.

44. Process as claimed in claim 43, which further comprises: (vii) packaging the composition.

45. Process as claimed in claim 43, wherein pinolenic acid or derivative thereof is incorporated in the water in the form of a powder.

46. Process as claimed in claim 45, wherein the powder is produced by spray drying pinolenic acid or its derivatives, or a fat comprising pinolenic acid or its derivatives, with protein and/or carbohydrate.

47. (canceled)

48. (canceled)

49. Beverage according to claim 7 comprising from 3 to 7% by weight fat.

50. Beverage according to claim 13 comprising 80 to 95% by weight water and from 0.2 to 4% by weight of thickening agent.

51. Beverage according to claim 30 having a pH between 3.0 and 4.1.

52. Beverage according to claim 35 comprising from 1 to 2.5% by weight cocoa.

53. Beverage according to claim 36 comprising from 0.05 to 0.3% by weight coffee powder.

54. Beverage as claimed in claim 42 wherein the pinolenic acid is in the form of a triglyceride.

55. Method for providing a nutritional benefit to a subject in need of same which comprises administering thereto a beverage composition according to claim 1.

56. Method according to claim 55 wherein the benefit is for body weight management.
